(19) United States
(12) Patent Application Publication
(10) Pub. No.: US 2009/0043638 A1
(43) Pub. Date: Feb. 12, 2009

(54) INTEGRATION OF REORDER-POINT BASED PLANNING AND TIME-PERIOD PLANNING

(76) Inventors: Michael Wilking, Sinsheim (DE); Frank Feiks, Mannhein (DE); Sameer Verma, Walldorf (DE); Dirk Hemming, Ingelheim (DE); Michael Schweitzer, Leimen (DE); Thorsten Bender, Ludwigshafen (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/834,331

(22) Filed: Aug. 6, 2007

(51) Int. Cl. G06Q 10/00

(52) U.S. Cl. 705/10; 705/28

(57) ABSTRACT

A system and method to perform time period planning and reorder point planning in a single planning run. Forecast data for a first subset of locations and inventory data for a second subset of locations is supplied to the planning system. Time period planning is performed on the first subset of locations and reordering point planning is performed on the second subset of locations in the same planning run.

### BACKGROUND

1. Field

Embodiments of the invention relate to supply chain management. More specifically, embodiments of the invention relate to integrated planning of time period planning locations and reorder point based planning locations within the supply chain.

2. Background

Historically, there have been two primary approaches to supply chain network planning. The first approach, time period planning (TPP), uses future demands over a time horizon and distribution planning is optimized for the entire horizon. In this type of planning, the horizon is divided into multiple time periods with distribution occurring within each time period. The second approach to planning, reorder point based planning (ROP), is an approach where distribution planning is driven by a shortfall of available quantities below a minimum level known as the reorder point. Both approaches seek to achieve optimization within their given context. The first approach optimizes for a planning horizon, while the second approach replenishes for current demands without optimization for future demands.

Commonly, TPP is used for sophisticated scenarios and critical parts, while ROP is used for simple scenarios and/or noncritical parts. ROP has the advantage of relative simplicity and minimal computational effort. In real networks, it may be necessary or desirable to use TPP for one location within the supply chain and ROP for another location within the supply chain for the same product. Unfortunately, since ROP only calculates the demand for the current day and TPP calculates the demand over the entire planning horizon, it has not been possible to plan for both TPP and ROP locations in a single planning run.

Performing TPP and ROP in consecutive planning runs leads to the risk that TPP locations are preferred over ROP locations or vice versa. Another risk of sequential planning is that the demands from a child ROP location may be inaccurately considered under a TPP calculation for the parent.

### SUMMARY OF THE INVENTION

A system and method to perform time period planning and reorder point planning in a single planning run is disclosed. Forecast data for a first subset of location products and inventory data for a second subset of location products is supplied to the planning system. Time period planning is performed on the first subset of location products and reordering point planning is performed on the second subset of location products in the same planning run.

### BRIEF DESCRIPTION OF DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a multiechelon distribution chain in which an embodiment of the invention might be used.

FIG. 2 is a flow diagram operation according to one embodiment of the invention.

FIG. 3 is a diagram of a determination of order quantity at a reorder point location product in accordance with one embodiment of the invention.

FIG. 4A is a diagram of calculation of a shortage in a ROP location product of one embodiment of the invention.

FIG. 4B is a diagram of determination of an excess in an ROP location product according to one embodiment of the invention.

FIG. 5 is a block diagram of the system according to one embodiment of the invention.

### DETAILED DESCRIPTION

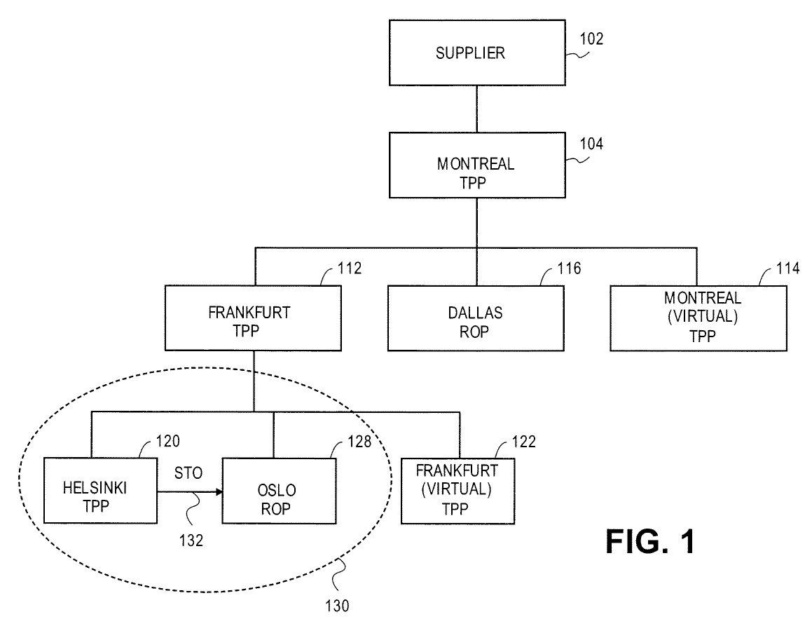

FIG. 1 is a block diagram of a multiechelon distribution chain in which an embodiment of the invention might be used. The supplier 102 supplies a product to distribution chain through an entry location, in this case Montreal 104, which for purposes of this example is a time period planning (TPP) location product. In the next echelon, it is Frankfurt 112 a TPP location product, Dallas 116, an ROP location product and Montreal (Virtual) 114 a TTP location product.

Frankfurt 112 is a child of Montreal 104, but the parent of Helsinki 120, Oslo 128 and Frankfurt (Virtual) 122. Each of Dallas 116, Montreal (Virtual) 114, Helsinki 120, Oslo 128 and Frankfurt (Virtual) 122 are customer facing location products. In creating the distribution plan, the demand of child location products must be considered at the parent location products. Thus, distribution for Helsinki 120, Oslo 128 and Frankfurt (Virtual) 122 must be considered in planning the distribution to Frankfurt 112. It is necessarily the case that any parent location product having children that are TPP location products must itself be a TPP location products. This is true because it is impossible to do TPP planning for a child if the parent is using ROP planning since the availability of the product to satisfy demand in a subsequent period of the time horizon cannot be assured. The corollary is also true; any parent that is an ROP location product must only have children that are ROP location products.

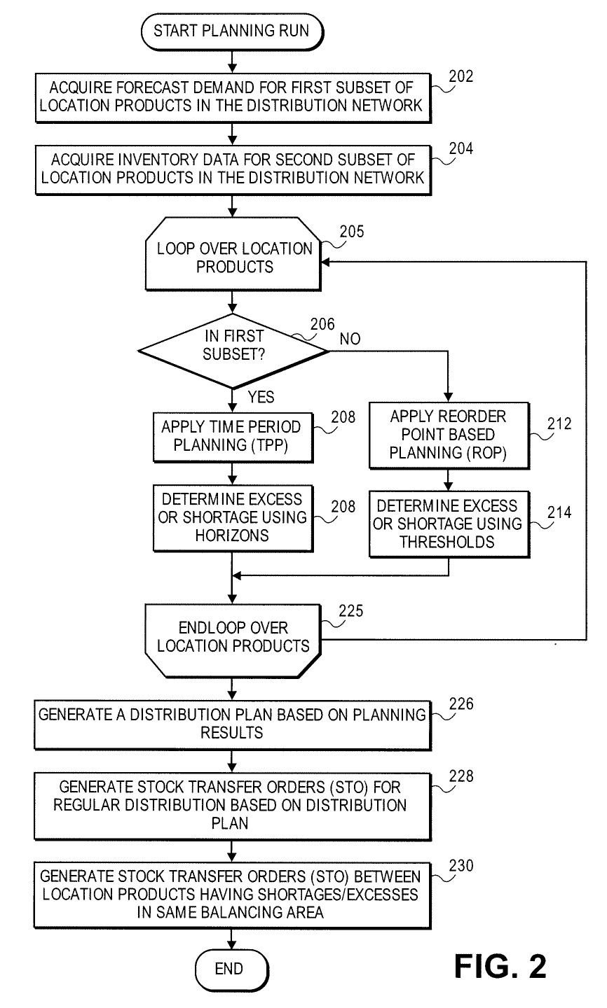

FIG. 2 is a flow diagram operation according to one embodiment of the invention. At block 202, a forecast of demand is obtained for a first subset of location products in the distribution network. In this case, that subset is the subset of location products which will be subject to TPP for the product in question. (Referring to FIG. 1, Montreal 104, Frankfurt 112, Montreal (Virtual) 114, Helsinki 120 and Frankfurt (Virtual) 122 would be in the first subset). At block 204, inventory data is obtained for a second subset of location products in the distribution network. In this case, the second subset of locations are those location products subject to ROP. (Referring to FIG. 1, Dallas 116 and Oslo 128 would be in the second subset).

At block 205, the process begins to loop over all location products. For each location product at decision block 206, it is determined whether location is in the first subset. In one embodiment, this may be accomplished by a flag in the master data which indicates whether ROP is relevant for the location product. If the location product is in the first subset, e.g., the ROP relevant flag is not set, time period planning is applied to the forecast demand over the planning horizon at block 208. At block 210, a determination is made whether an excess or shortage exists at the location and the amount of excess or shortage. In TPP location products an excess or shortage may be determined by comparing demand and receipts within a certain excess/shortage horizon. If at decision block 206 it is determined that the location product is not in the first subset, e.g., the ROP relevant flag is set, the reorder point planning is applied at block 212. In one embodiment, reorder point planning is accomplished by using time period planning with a single period for the horizon. Thus, in effect, distribution requirements for a reorder point become immediate as opposed to being graduated to different periods within the time horizon. In one embodiment, within deployment priority tiers, demand from an ROP location product is given the same priority as the demand for the first period of a TPP location. In ROP location products an excess threshold and shortage threshold may used to represent the anticipated demand in the determination of excess and shortage in block 214, because the demands are not known for ROP location products. The loop ends at block 225.

Having planned for each location, a distribution plan based on the planning results of the blocks 208 and 212 for all location products is generated at block 226.

From the distribution plan, stock transfer orders may be generated for regular distribution at block 228. Additionally for location products in the same inventory balancing area stock transfer orders may be generated based on excesses and shortages at block 230. In one embodiment, the distribution plan and stock transfer orders are calculated planning type agnostic. Stated differently, DRP, deployment and inventory balancing have no preference between different planning type location products when generating distribution plan respectively STOs.

While the foregoing description is undertaken in connection with a flow diagram, it should be understood that some elements of the flow may occur in an order other than set forth herein. Some elements may occur in parallel. All such modifications are deemed within the scope of various embodiments of the invention.

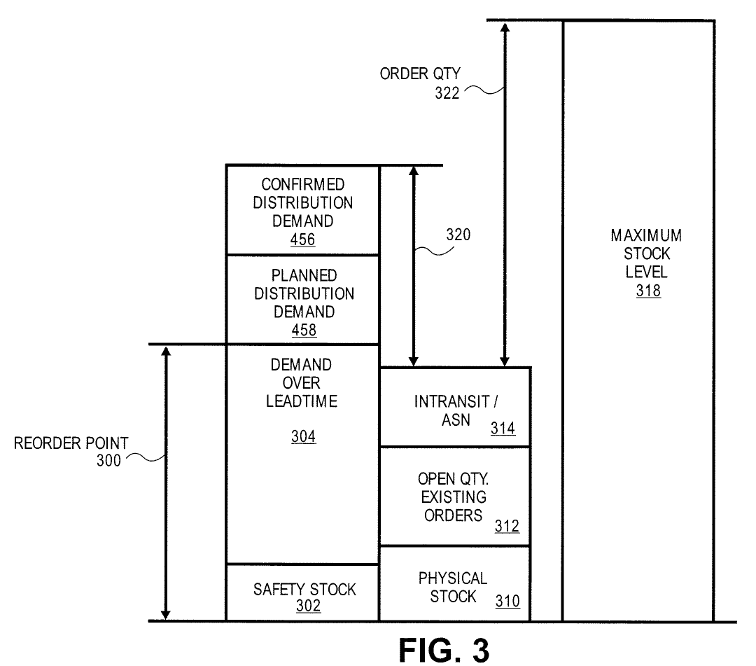

FIG. 3 is a diagram of a determination of order quantity for distribution planning at a reorder point location product in accordance with one embodiment of the invention. Reorder point 300 is defined as the aggregate of safety stock 302 and demand over lead time 304. In the absence of other factors, the order quantity 320 then becomes the difference between the aggregate of reorder point 300, planned distribution demand 458 and confirmed distribution demand 456 and the aggregate of goods in transit 314, open quantity of existing orders 312, and physical stock 310. However, for some location products employing ROP, may be flagged as rounding to the maximum stock level. In such case, the order quantity 322 is determined as the difference between the maximum stock level 318 and the aggregate of goods in transient 314, open quantity of existing orders 312 and physical stock 310, if this difference is greater then the order quantity 320. Open quantity of existing orders 312 includes all open receipt quantities of stock transfer orders (STO's), purchase orders (PO's), etc. In some embodiments, a user can customize whether receipt quantities are considered only within the lead time or over the entire time horizon. However, no order is placed until that aggregate falls below the aggregate of reorder point 300, planned distribution demand 458 and confirmed distribution demand 456.

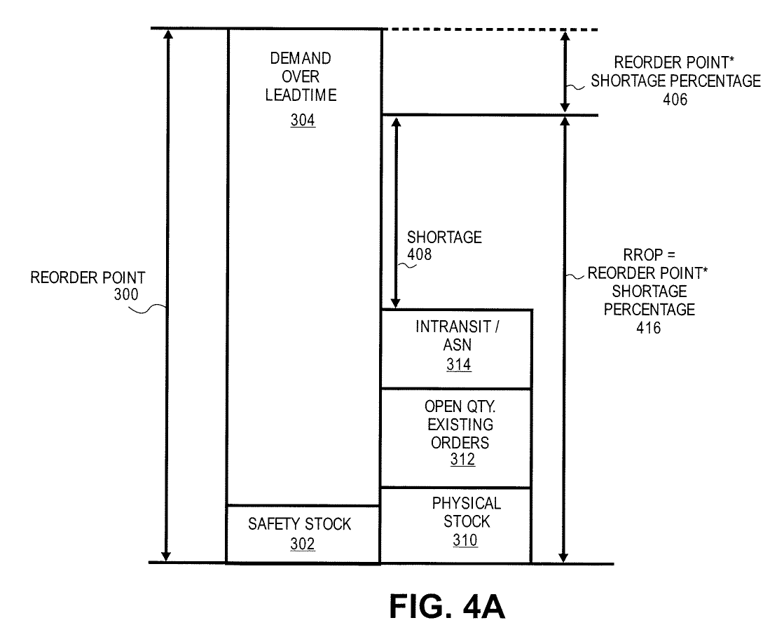

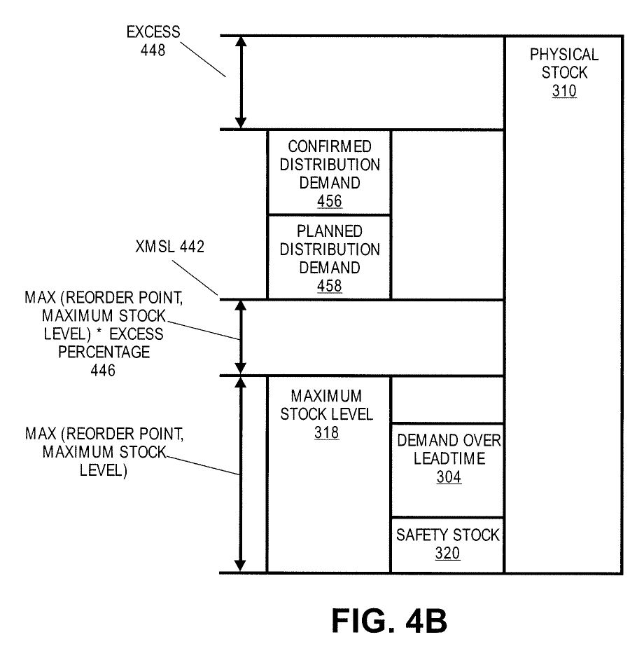

FIG. 4A is a diagram of calculation of a shortage in a ROP location product of one embodiment of the invention. As noted above, the reorder point 300 for a location product is defined to be the safety stock 302 plus the demand over the lead time 304. A shortage percentage 406 of the reorder point 300 is subtracted from the reorder point 300 to find a reduced reorder point (RROP) 416. The actual shortage 408 is determined as a difference between the RROP 416 and the aggregate of the physical stock 310, the open quantities of existing orders 312 and the goods in transit 314. By using RROP 416 rather than the reorder point, effectively provides some hysteresis which increases inventory stability by preventing generation of stock transfer orders at marginal levels below reorder point 300.

FIG. 4B is a diagram of determination of an excess in an ROP location product according to one embodiment of the invention. As shown, physical stock 310 exceeds a maximum stock level 318. To determine an excess, the maximum stock level 318 is increased by an excess percentage 446 to find an excess maximum stock level (XMSL) 442. As with the shortage percentage discussed in connection with FIG. 4A, the excess percentage provides a hysteresis, which increases inventory stability and avoids unnecessary stock transfers where the maximum stock level is only marginally exceeded.

The excess 448 is given by the difference between physical stock 310 and the aggregate of XMSL and planned distribution demand 458, confirmed distribution demand 456. These demand components 454 and 456 permit the modeling of demand spikes, such as might result from a promotion. By using them in the excess calculation STO's that transfer out physical stock inventoried for a special demand event, such as a promotion are avoided.

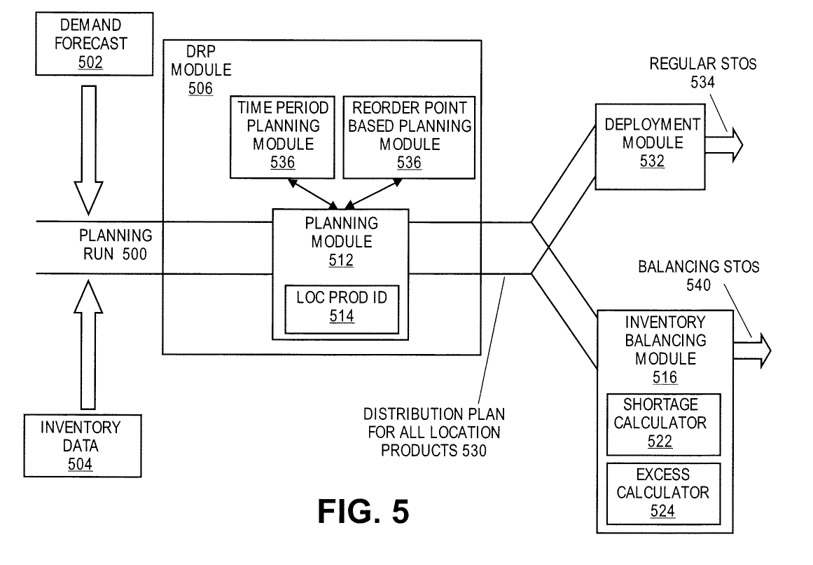

FIG. 5 is a block diagram of the system according to one embodiment of the invention. Demand forecast data 502 for a first subset of location products, an inventory data 504 for a second subset of location products are supplied to planning run 500. A distribution requirement planning module 506 includes a planning module 512 with the location product identifier 514 therein. Location product identifier identifies for each location product whether the location product is a TPP product location or a ROP product location. For one embodiment, this may be done by checking a flag in the master data for that product location. In the event that product location is a TPP product location, the TPP module 536 planning over a multiple period horizon is called. However, if location is a ROP location product, the ROP planning module 536 is called. For one embodiment the ROP planning module may just call the TPP planning module using a single period for the entire horizon. Once all the location products have been planned, the DRP module 506 passes the distribution plan 530 for all locations to a deployment module 532, which generates stock transfer orders 534 for regular distribution. Additionally the distribution plan is passed to a inventory balancing module 516, which generates stock transfer orders for balancing between locations in a balancing area. The inventory balancing module interacts with a shortage calculator 522 and an excess calculator 524, which calculate shortages and excesses respectively consistent with the type of location product being planned.

In some instances, some of the stock transfer orders may be balancing stock transfer orders to cause the transfer of products between location pairs having excess/shortages to reduce or eliminate the excess and/or shortage. For example, referring to FIG. 1, if 130 constitutes a balancing area, the stock transfer order 132 between Helsinki 120 and Oslo 128 may reduce or eliminate an excess in Helsinki 120 while reducing or eliminating a shortage in Oslo 128. However, even assuming that Dallas 116 had an excess, it could not transfer the excess to Oslo 128 as they are not both in balancing area 130.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving a forecast demand of location products for a first subset of location products in a distribution network;
obtaining inventory data about location products for a second subset of location products in the distribution network; and
using time period planning for the location products of the first subset and reorder point planning for location products of the second subsets respectively in a single planning run to generate a distribution plan for all location products.

2. The method of claim 1 wherein using reorder point planning comprises:
using time period planning with a horizon set to one period.

3. The method of claim 1 wherein using comprises:
applying time period planning to all parent location products having a child location product in the first subset.

4. The method of claim 1 further comprising:
deploying a planned quantity of the location product to each product location in the distribution network.

5. The method of claim 1 further comprising:
determining for each location product an excess or a shortage; and
generating a stock transfer order between a first location product having an excess and a second location product having a shortage.

6. The method of claim 5 wherein determining an excess for a location product in the second subset comprises:
increasing a maximum stock level by an excess percentage to get an excess maximum stock level; and
reducing a physical stock value by the excess maximum stock level and distribution demand.

7. The method of claim 5 wherein determining a shortage for a location in the second subset comprises:
reducing a reorder point by a shortage percentage to get a reduced reorder point; and
comparing the reduced reorder point to an aggregate of physical stock, goods in transit and open order quantities.

8. A system comprising:
a demand forecasting module to generate a demand forecast for a first subset of location products in a supply chain;
an inventory data source to supply inventory data for a second subset of location products in the supply chain; and
a distribution resource planning (DRP) module to generate a distribution plan for the first subset of locations using time phased planning and the second subset of location using reorder point planning in a single planning run.

9. The system of claim 8 wherein the DRP module comprises:
a location product identifier to determine if the location product is in the first or the second subset
a time period planning (TPP) module to accept demand forecast data and generate a distribution plan for the first subset; and
a calculation module to accept inventory data for the second subset and generate a distribution plan for the second subset by calling the time period planning module setting the horizon to a single period.

10. The system of claim 9 where the calculation module comprises:
a shortage calculator; and
an excess calculator.

11. The system of claim 8 further comprising:
a deployment module to create stock transfer orders (STO's) to fulfill the distribution plan.

12. The system of claim 11 wherein the inventory balancing module generates STO's between two locations when one location has a shortage and the other location has an excess.

13. A machine readable medium having instructions therein that when executed by the machine cause the machine to:
receive a forecast demand of a product for a first subset of location products in a distribution network;
obtain inventory data about location products for a second subset of location products in the distribution network; and
use time phased planning and reorder point planning to generate a distribution plan for the location products of the first and second subsets respectively in a single planning run.

14. The machine readable medium of claim 13, wherein instructions causing the machine to use cause the machine to:
apply time phased planning to all parent location products having a child location in the first subset.

15. The machine readable medium of claim 13, having instructions that when executed further cause the machine to:
generate stock transfer orders to deploy a planned quantity of the location product to each location product in the distribution network.

16. The machine readable medium of claim 13, having instructions that when executed further cause the machine to:
determine for each location product an excess or a shortage; and
generate a stock transfer order between a first location product having an excess and a second location product having a shortage.

17. The machine readable medium of claim 16, wherein instructions causing the machine to determine an excess comprise instructions causing the machine to:
increase a maximum stock level by an excess percentage to get an excess maximum stock level; and
reduce a physical stock value by the excess maximum stock level and distribution demand.

18. The machine readable medium of claim 16, wherein instructions causing the machine to determine a shortage comprise instructions causing the machine to:
reduce a reorder point by a shortage percentage to get a reduced reorder point; and
compare the reduced reorder point to an aggregate of physical stock and goods in transit and open order quantities.
